(19) United States
(12) Patent Application Publication
(10) Pub. No.: US 2026/0338012 A1
(43) Pub. Date: Oct. 29, 2026

(54) HANDLE DEVICE AND VEHICLE

(71) Applicant: Illinois Tool Works Inc., Glenview, IL (US)

(72) Inventor: Chunfeng JIANG, Shanghai (CN)

(21) Appl. No.: 19/658,023

(22) Filed: Apr. 24, 2026

(30) Foreign Application Priority Data
Apr. 25, 2025 (CN) 2025105301450
Apr. 21, 2026 (CN) 2026105335343

(51) Int. Cl. E05B 85/10

(52) U.S. Cl. CPC E05B 85/107

(57) ABSTRACT

A handle device includes a handle seat, a handle movable between a retracted position and a deployed position, a first link arm, a second link arm, and a coupling rod. The first link arm has a first end rotatably coupled to the handle and a second end coupled to the handle seat, and is configured to rotate relative to the handle seat under actuation by a driving device. The second link arm has a first end rotatably coupled to the handle. The coupling rod is movably coupled to the handle seat for linear motion and is rotatably coupled to a second end of the second link arm. The coupling rod is operatively coupled to the first link arm such that rotation of the first link arm drives linear movement of the coupling rod, which in turn drives movement of the second link arm to move the handle between the retracted position and the deployed position.

### RELATED APPLICATION

The present disclosure claims priority to Chinese Patent Application Nos. 202510530145.0, filed on Apr. 25, 2025, and 2026105335343.0, filed on Apr. 21, 2026; each of which is entitled “HANDLE DEVICE AND VEHICLE” and is incorporated herein by reference in its entirety.

### TECHNICAL FIELD

The present disclosure relates to a handle device and a vehicle.

### BACKGROUND

In the prior art, hidden handle devices for vehicles usually use a linkage mechanism to control the movement of the handle. A driving mechanism drives one link arm of the linkage mechanism to rotate, resulting in the movement of other components of the linkage mechanism, thus enabling the handle to translate between a retracted position and a deployed position.

### SUMMARY

The present disclosure relates generally to a handle device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is an exploded view of a handle device according to a first embodiment of the present disclosure.

FIG. 2A is a front view of the handle device shown in FIG. 1 when the handle is in a retracted position.

FIG. 2B is a front view of the handle device shown in FIG. 2A when the handle just reaches a deployed position.

FIG. 2C is a front view of the handle device shown in FIG. 2A when the handle is retained in the deployed position.

FIG. 3A is a front view of a handle device according to a second embodiment of the present disclosure when the handle is in a retracted position.

FIG. 3B is a front view of the handle device shown in FIG. 3A when the handle just reaches a deployed position.

FIG. 3C is a front view of the handle device shown in FIG. 3A when the handle is retained in the deployed position.

FIG. 4A is a schematic view of a vehicle having the handle device of the present disclosure.

FIG. 4B is a schematic view of a vehicle door of the vehicle shown in FIG. 4A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

It has been discovered that existing handle devices require a relatively large operating space during the deployment of the handle, which is disadvantageous for the arrangement of other components on a vehicle door.

To at least partially solve above technical problems, according to one aspect of the present disclosure, a handle device is provided, including a handle seat, a handle, a first link arm, a second link arm and a coupling rod. The handle has a deployed position and a retracted position; the first link arm is rotatably connected at a first end thereof to the handle and rotatably connected at a second end thereof to the handle seat, wherein the first link arm is configured to rotate relative to the handle seat under the drive of a driving device; the second link arm is rotatably connected at a first end thereof to the handle; the coupling rod is linearly movably connected to the handle seat, the second link arm is rotatably connected at a second end thereof to the coupling rod, and the coupling rod is operatively coupled with the first link arm so as to be driven by the first link arm to move linearly when the first link arm is driven to rotate, thereby driving the second link arm to move, and thus enabling the handle to move from the retracted position to the deployed position.

According to some examples of the present disclosure, the first link arm is provided with an arcuate slot, the coupling rod being provided with a pin, the pin being received in the arcuate slot and movable within the arcuate slot, and the coupling rod being operatively coupled with the first link arm via the pin and the arcuate slot.

According to some examples of the present disclosure, the handle device further includes a driving device. The driving device includes an actuator and a transmission member; the actuator being configured to drive the transmission member to rotate. The first link arm includes an engaging portion, and the transmission member is operatively coupled with the engaging portion of the first link arm to enable the actuator to drive the first link arm to rotate; and the transmission member and the engaging portion of the first link arm form a speed reduction transmission mechanism.

According to some examples of the present disclosure, the transmission member includes a transmission portion and a retaining portion adjacent to each other in a circumferential direction thereof, the transmission member being configured to drive the first link arm to rotate through cooperation between the transmission portion and the engaging portion of the first link arm, and to retain the handle in the deployed position through cooperation between the retaining portion and the engaging portion of the first link arm.

According to some examples of the present disclosure, when the retaining portion of the transmission member cooperates with the engaging portion of the first link arm, the actuator is prevented from driving the first link arm to rotate via the transmission member.

According to some examples of the present disclosure, the transmission portion of the transmission member includes a cam surface, and the retaining portion of the transmission member includes an arc surface connected to an end of the cam surface having a larger radius; wherein the engaging portion of the first link arm includes a rotatable wheel; and wherein when the cam surface is in contact with the wheel, the actuator is configured to drive the first link arm to rotate via the transmission member, and when the arc surface is in contact with the wheel, the actuator is prevented from driving the first link arm to rotate via the transmission member.

According to some examples of the present disclosure, the engaging portion of the first link arm further comprises a protrusion, the wheel being rotatably disposed on the protrusion.

According to some examples of the present disclosure, the radius of the arc surface is substantially the same as the maximum radius of the cam surface.

According to some examples of the present disclosure, the transmission portion of the transmission member includes a first partial gear, and the retaining portion of the transmission member includes a locking rod connected to the first partial gear; wherein the engaging portion of the first link arm includes a second partial gear provided with a locking slot; wherein when the first partial gear meshes with the second partial gear, the actuator is allowed to drive the first link arm to rotate via the transmission member, and when the first partial gear disengages from the second partial gear, a part of the locking rod enters the locking slot, preventing the actuator from driving the first link arm to rotate via the transmission member.

According to some examples of the present disclosure, the locking rod includes a locking pin provided at a distal end thereof, the locking pin being configured to move into and out of the locking slot.

According to some examples of the present disclosure, the shape of the locking slot matches the movement trajectory of the locking pin during rotation, such that the movement of the locking pin in the locking slot does not cause the first link arm to rotate.

According to some examples of the present disclosure, the locking slot is an arcuate slot.

According to some examples of the present disclosure, the handle seat and the coupling rod are provided with limiting means connecting the coupling rod to the handle seat in a linearly movable manner.

According to some examples of the present disclosure, the handle translates between the retracted position and the deployed position.

According to another aspect of the present disclosure, a vehicle is provided, including the aforementioned handle device.

The handle device of the present disclosure requires a small operating space and has a compact structure while ensuring a relatively large driving force.

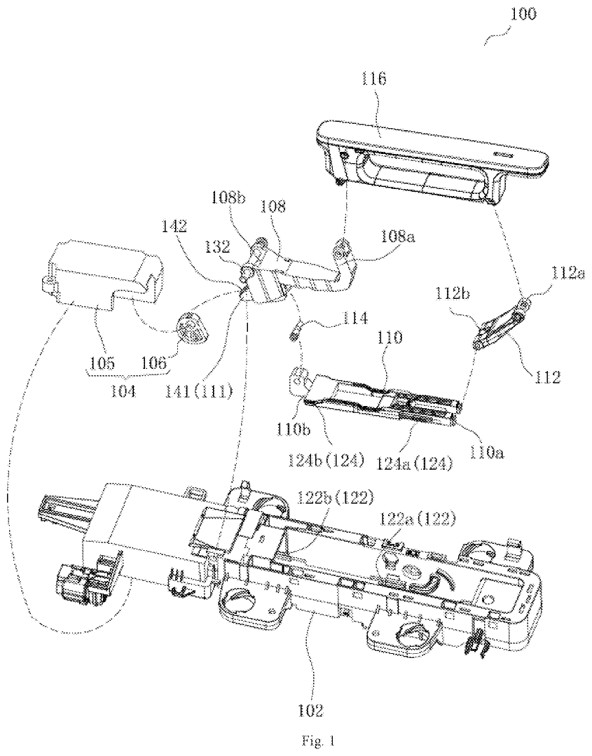

FIG. 1 is an exploded view of a handle device 100 according to a first embodiment of the present disclosure.

As shown in FIG. 1, the handle device 100 includes a handle seat 102, a handle 116, a first link arm 108, a coupling rod 110, a second link arm 112 and a driving device 104. The handle 116 has a deployed position and a retracted position relative to the handle seat 102, and can translate between the retracted position and the deployed position. The first link arm 108 is rotatably connected at a first end 108a thereof to the handle 116, and rotatably connected at a second end 108b thereof to the handle seat 102 via a shaft 132. The first link arm 108 is rotatable relative to the handle seat 102 under the drive of the driving device 104. The second link arm 112 is rotatably connected at a first end 112a thereof to the handle 116, and rotatably connected at a second end 112b thereof to a first end 110a of the coupling rod 110. The coupling rod 110 is linearly movably connected to the handle seat 102, and the coupling rod 110 is operatively coupled at a second end 110b thereof with the first link arm 108 so as to be driven by the first link arm 108 to move linearly when the first link arm 108 is driven to rotate. Thus, the handle 116, the first link arm 108, the coupling rod 110 and the second link arm 112 together form a four-bar linkage mechanism for implementing the deployment and retraction operations of the handle 116 relative to the handle seat 102.

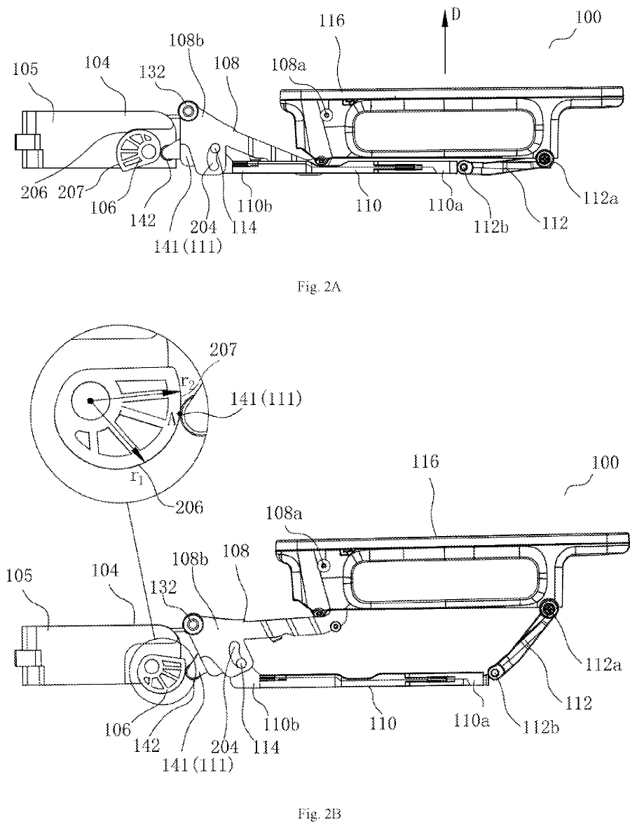

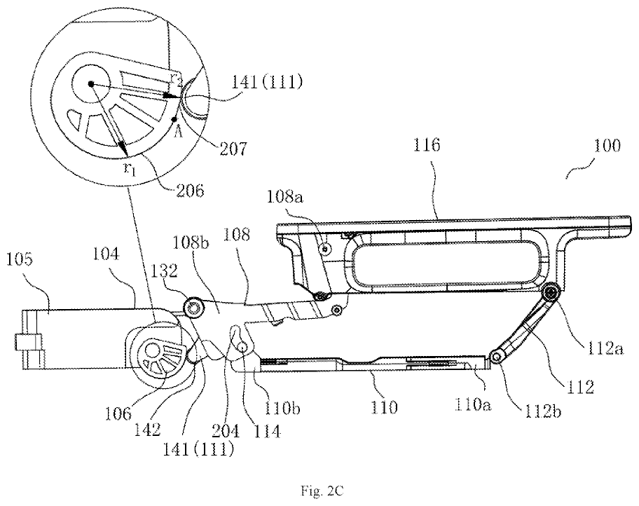

Still as shown in FIG. 1, the coupling rod 110 is provided with a pin 114 at the second end 110b. The pin 114 is received in an arcuate slot 204 of the first link arm 108 (see FIGS. 2A-2B for details) and movable within the arcuate slot 204, whereby the rotation of the first link arm 108 can drive the coupling rod 110 to move linearly. The linear movement of the coupling rod 110 can drive the second link arm 112 to move. The handle 116 can translate from the retracted position to the deployed position under the combined action of the first link arm 108 and the second link arm 112. The handle seat 102 and the coupling rod 110 are provided with limiting means connecting the coupling rod 110 to the handle seat 102 in a linearly movable manner. In some embodiments, the limiting means include a slide rail provided on one of the handle seat 102 and the coupling rod 110, and a slider provided on the other one of the handle seat 102 and the coupling rod 110.

In the illustrated embodiment, the limiting means 122 includes a first slide rail 122a and a second slide rail 122b provided on the handle seat 102, and a first slider 124a and a second slider 124b provided on the coupling rod 110. The first slider 124a is disposed proximal to the first end 110a of the coupling rod 110, and the second slider 124b is disposed proximal to the second end 110b of the coupling rod 110. The first slider 124a and the second slider 124b are received in the first slide rail 122a and the second slide rail 122b respectively, so that the coupling rod 110 performs linear movement relative to the handle seat 102. As will be appreciated by those of ordinary skill in the art, the limiting means are not limited to the configuration described above.

With continued reference to FIG. 1, the driving device 104 includes an actuator 105 and a transmission member 106. The actuator 105 can drive the transmission member 106 to rotate. The transmission member 106 is connected, for example, to an output shaft of the actuator 105. The first link arm 108 includes an engaging portion 111, and the transmission member 106 is operatively coupled with the engaging portion 111 of the first link arm to enable the actuator 105 to drive the first link arm 108 to rotate via the transmission member 106. The transmission member 106 and the engaging portion 111 of the first link arm 108 form a speed reduction transmission mechanism. The engaging portion 111 of the first link arm 108 includes a protrusion 141 and a wheel 142 rotatably disposed on the protrusion 141. The wheel 142 is, for example, a roller. The rotation of the wheel 142 enables rolling contact between the engaging portion 111 of the first link arm 108 and the transmission member 106.

FIGS. 2A-2B are front views of the handle device shown in FIG. 1, illustrating the deployment process of the handle of the handle device, wherein FIG. 2A is a front view of the handle device when the handle is in the retracted position, and FIG. 2B is a front view of the handle device when the handle just reaches the deployed position, and FIG. 2C is a front view of the handle device when the handle is retained in the deployed position. To more clearly show the positions and connection relationships of the components of the handle device, the handle seat 102 is omitted in the figures.

As shown in FIGS. 2A-2B, the first link arm 108 is provided with an arcuate slot 204. The pin 114 on the coupling rod 110 is received in the arcuate slot 204 and is movable within the arcuate slot 204. The coupling rod 110 is operatively coupled with the first link arm 108 via the pin 114 and the arcuate slot 204, so that the first link arm 108 can drive the coupling rod 110 to move linearly. As will be appreciated by those of ordinary skill in the art, the driving of the coupling rod 110 by the first link arm 108 is not limited to the cooperation between the arcuate slot 204 and the pin 114 as described above. In other embodiments, a cam with specific varying curvature may be provided on the first link arm 108, and the coupling rod 110 is pushed by the rotation of the cam to move linearly.

Still as shown in FIGS. 2A-2B, the transmission member 106 includes a transmission portion and a retaining portion adjacent to each other in a circumferential direction thereof. The transmission member 106 drives the first link arm 108 to rotate through cooperation between the transmission portion and the engaging portion 111 of the first link arm 108, and retains the handle 116 in the deployed position through cooperation between the retaining portion and the engaging portion 111 of the first link arm 108. As shown in the enlarged view in FIG. 2B, the transmission portion of the transmission member 106 includes a cam surface 206, and the retaining portion of the transmission member 106 includes an arc surface 207. The rotational radius r₁ of the cam surface 206 gradually increases in the counterclockwise direction in the figure. The cam surface 206 is connected to the arc surface 207 at the end thereof where the rotational radius r₁ is the largest (i.e., at point A), and the rotational radius r₂ of the arc surface 207 is substantially the same as the maximum rotational radius of the cam surface 206. Therefore, when the cam surface 206 of the transmission member 106 is in contact with the wheel 142 of the first link arm 108, the clockwise rotation of the transmission member 106 in the figure can push the first link arm 108 to rotate, whereas when the transmission member 106 rotates to a position where the arc surface 207 contacts the wheel 142 of the first link arm 108, the rotation of the transmission member 106 no longer pushes the first link arm 108 to rotate. That is, when the arc surface 207 of the transmission member 106 contacts the engaging portion 111 of the first link arm 108, the transmission member 106 can rotate, but could not drive the first link arm 108 to move. Instead, transmission member 106 retains the handle 116 in the deployed position via the arc surface 207.

As shown in FIG. 2A, the handle 116 is in the retracted position, and the cam surface 206 is in contact with the wheel 142 of the engaging portion 111 of the first link arm 108. When the driving device 104 drives the handle 116 to move from the retracted position to the deployed position, the transmission member 106 is driven by the actuator 105 to rotate in the clockwise direction in FIG. 2A, and drives the first link arm 108 to rotate via the cam surface 206. The first link arm 108 drives the coupling rod 110 to move linearly relative to the handle seat through the cooperation between the arcuate slot 204 on the first link arm 108 and the pin 114 on the coupling rod 110. During the linear movement, the coupling rod 110 pushes the second link arm 112 to move. Thus, the handle 116 translates substantially in the direction indicated by arrow D in the figure toward the deployed position under the combined action of the first link arm 108 and the second link arm 112.

As shown in FIG. 2B, as the transmission member 106 rotates, when the position where the transmission member 106 contacts the wheel 142 switches from the cam surface 206 to the arc surface 207 (for example, at point A), the handle 116 is in a state where it just reaches the deployed position.

After the handle 116 reaches the deployed position as shown in FIG. 2B, the arc surface 207 of the transmission member 106 is in contact with the wheel 142 of the engaging portion 111 of the first link arm 108. Since the rotational radius r₂ of the arc surface 207 of the transmission member 106 is constant, even if the transmission member 106 continues rotating, the actuator 105 cannot continue to drive the first link arm 108 to rotate via the transmission member 106. Correspondingly, the coupling rod 110 and the second link arm 112 no longer move. Therefore, the subsequent rotation of the transmission member 106 does not change the position of the handle 116, but instead retains the handle 116 in the deployed position via the arc surface 207, as shown in FIG. 2C.

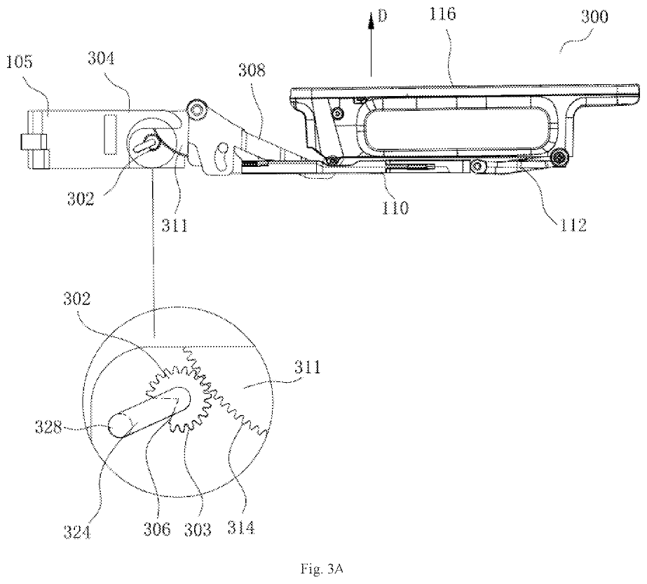

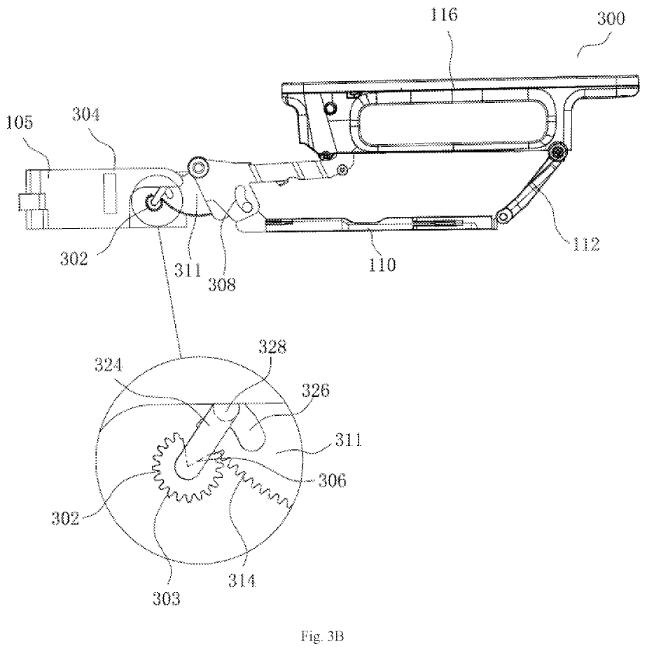

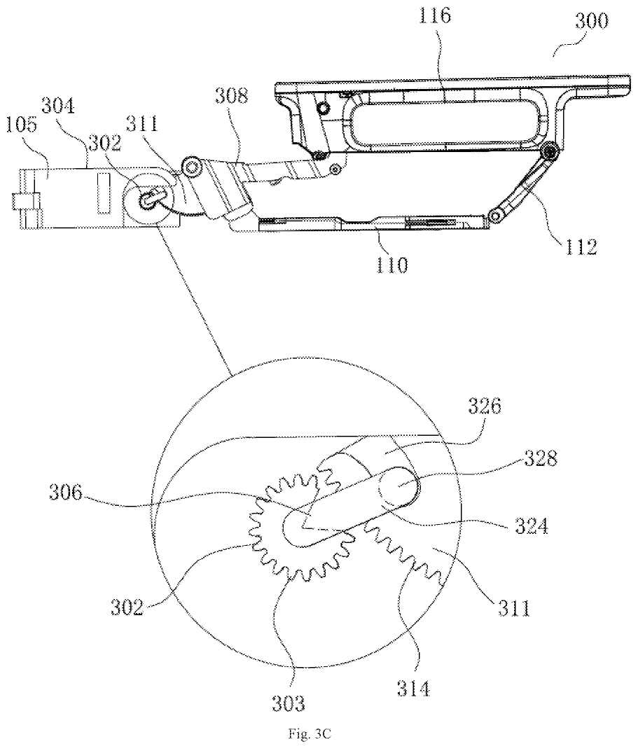

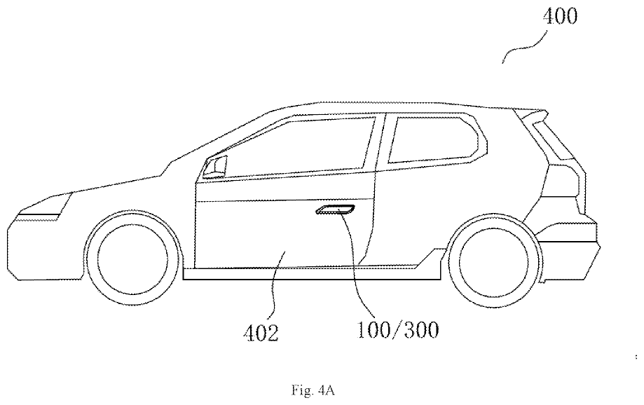

FIGS. 3A-3C show a second embodiment of the present disclosure, wherein FIG. 3A is a front view of the handle device when the handle is in the retracted position, FIG. 3B is a front view of the handle device when the handle just reaches the deployed position, and FIG. 3C is a front view of the handle device when the handle is retained in the deployed position. The difference between the handle device 300 in the second embodiment and the handle device 100 in the first embodiment is that the structure of the transmission member of the handle device 300 and the structure of the part of the first link arm cooperating with the transmission member are different from the corresponding structures of the handle device 100. The identical parts will not be described again.

As shown in FIGS. 3A-3C, the handle device 300 has a transmission member 306 and a first link arm 308 different from those of the first embodiment. The transmission portion of the transmission member 306 includes a first partial gear 303. The first partial gear 303 is not a complete gear, which has teeth only over a segment of its circumference and has no teeth over the other segments of its circumference. The first partial gear 303 is substantially sector-shaped.

The retaining portion of the transmission member 306 includes a locking rod 324. The locking rod 324 is connected to the first partial gear 303 and rotates synchronously with the first partial gear 303. The locking rod 324 is aligned with the toothless segment of the first partial gear 303. The locking rod 324 includes a locking pin 328 disposed at a distal end thereof.

The engaging portion 311 of the first link arm 308 includes a second partial gear 314. The second partial gear 314 is also not a complete gear, which is provided with teeth only over a segment thereof. The second partial gear 314 is substantially sector-shaped. The second partial gear 314 is provided with a locking slot 326, and the locking pin 328 on the locking rod 324 can move into and out of the locking slot 326. The shape of the locking slot 326 matches the movement trajectory of the locking pin 328 as rotating with the locking rod 324. The locking slot 326 is, for example, an arcuate slot.

When the first partial gear 303 meshes with the second partial gear 314, the actuator 105 can drive the first link arm 308 to rotate via the transmission member 306. When the first partial gear 303 disengages from the second partial gear 314, a part of the locking rod 324 (i.e., the locking pin 328) enters the locking slot 326, and the actuator 105 could not drive the first link arm 308 to rotate via the transmission member 306.

As shown in FIG. 3A, the handle 116 is in the retracted position, and the first partial gear 303 meshes with the second partial gear 314. When the driving device 104 drives the handle 116 to move from the retracted position to the deployed position, the transmission member 306 is driven by the actuator 105 to rotate in the clockwise direction in FIG. 3A, and drives the second partial gear 314 to rotate via the first partial gear 303. The first link arm 108 drives the coupling rod 110 to move linearly relative to the handle seat through the cooperation between the arcuate slot 204 on the first link arm 108 and the pin 114 on the coupling rod 110. During the linear movement, the coupling rod 110 pushes the second link arm 112 to move. Thus, the handle 116 translates substantially in the direction indicated by arrow D in the figure toward the deployed position under the combined action of the first link arm 108 and the second link arm 112.

As shown in FIG. 3B, as the transmission member 306 rotates, when the first partial gear 303 disengages from the second partial gear 314, the handle 116 is in a state where it just reaches the deployed position, and the locking pin 328 begins to enter the locking slot 326.

After the handle 116 reaches the deployed position shown in FIG. 3B, since the shape of the locking slot 326 matches the movement trajectory of the locking pin 328 as rotating with the locking rod 324, the movement of the locking pin 328 within the locking slot 326 will not drive the first link arm 308 to rotate. Correspondingly, the coupling rod 110 and the second link arm 112 also no longer move. Therefore, the subsequent rotation of the transmission member 306 does not change the position of the handle 116, but retains the handle 116 in the deployed position via the locking pin 328, as shown in FIG. 3C.

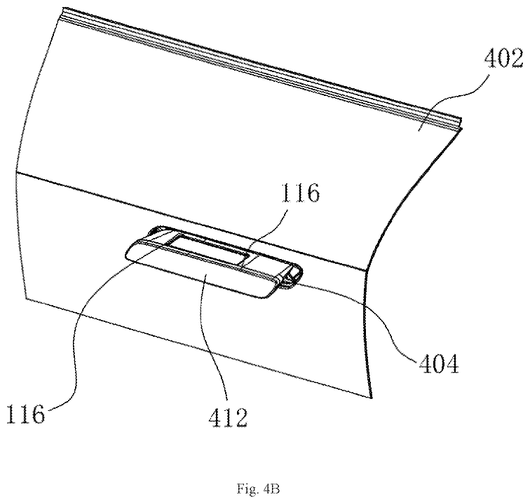

FIGS. 4A-4B illustrate a usage scenario of the handle device, wherein FIG. 4A is a schematic view of a vehicle having the handle device, and FIG. 4B is a schematic view of a vehicle door.

As shown in FIGS. 4A-4B, the present disclosure also protects a vehicle 400, which has a vehicle door 402. The vehicle door 402 is provided with a handle receiving cavity 404 for mounting the aforementioned handle device 100/300. When not in use, the handle 116 of the handle device is in the retracted position, and a handle outer surface 412 remains flush with an outer surface of the vehicle door 402. When a door opening operation needs to be performed, the handle 116 can be driven from the retracted position to the deployed position as shown in FIG. 4B, thereby allowing a user to pull the handle 116.

In present disclosure, the structural configuration of the handle device enables the coupling rod, connected to the first link arm directly driven by the driving device, to move linearly during the deployment of the handle. The movement of components in the handle device requires a small operating space, so that the handle device has a more compact structure, and the movement of the handle is smoother and steadier.

Furthermore, by configuring the transmission member of the driving device, the handle device of the present disclosure can prevent the actuator of the driving device from driving the first link arm to rotate at the terminal phase of its driving stroke (i.e., the driving stage from decelerated rotation to a complete stop). Thus, during the deployment of the handle, the tolerance at the terminal phase of the actuator's driving stroke is avoided, making the deployment distance of the handle each time more accurate and consistent.

In addition, the transmission member and the engaging portion on the first link arm of the handle device of the present disclosure together form a speed reduction mechanism, providing a relatively large driving force to the handle.

While the present disclosure has been described in conjunction with the examples of embodiments outlined above, various alternatives, modifications, variations, improvements and/or substantial equivalents, whether known or that are or may be presently foreseen, may become apparent to those having at least ordinary skill in the art. The technical effects and technical problems in the specification are exemplary and are not limiting. It should be noted that the embodiments described in the specification may have other technical effects and can solve other technical problems. Accordingly, the examples of embodiments of the present disclosure, as set forth above, are intended to be illustrative, not limiting. Various changes may be made without departing from the spirit or scope of the disclosure. Therefore, the present disclosure is intended to embrace all known or earlier developed alternatives, modifications, variations, improvements and/or substantial equivalents.

### REFERENCE NUMERALS

Handle Device 100/300
Handle Seat 102
Driving Device 104/304
Actuator 105
Transmission Member 106/306
First Link Arm 108/308
First End 108a of the First Link Arm 108
Second End 108b of the First Link Arm 108
Coupling Rod 110
First End 110a of the Coupling Rod 110
Second End 110b of the Coupling Rod 110
Engaging Portion 111/311
Second Link Arm 112
First End 112a of the Second Link Arm 112
Second End 112b Of The Second Link Arm 112
Pin 114
Handle 116
Limiting Means 122
First Slide Rail 122a
Second Slide Rail 122b
First Slider 124a
Second Slider 124b
Shaft 132
Wheel 142
Arcuate Slot 204
Cam Surface 206
Arc Surface 207
First partial gear 303
Rocker Arm 312
Second partial gear 314
Toothless Portion 316
Proximal End 322 of the Rocker Arm
Locking Rod 324
locking Slot 326
Locking Pin 328
Vehicle 400
Vehicle Door 402
Handle Receiving Cavity 404
Handle Outer Surface 412

1. A handle device, comprising:
a handle seat;
a handle having a deployed position and a retracted position;
a first link arm rotatably connected at a first end thereof to the handle and rotatably connected at a second end thereof to the handle seat, wherein the first link arm is configured to rotate relative to the handle seat under the drive of a driving device;
a second link arm rotatably connected at a first end thereof to the handle; and
a coupling rod linearly movably connected to the handle seat, the second link arm being rotatably connected at a second end thereof to the coupling rod, and the coupling rod being operatively coupled with the first link arm so as to be driven by the first link arm to move linearly when the first link arm is driven to rotate, thereby driving the second link arm to move, and thus enabling the handle to move from the retracted position to the deployed position.

2. The handle device according to claim 1, wherein the first link arm is provided with an arcuate slot, the coupling rod being provided with a pin, the pin being received in the arcuate slot and movable within the arcuate slot, and the coupling rod being operatively coupled with the first link arm via the pin and the arcuate slot.

3. The handle device according to claim 1, further comprising the driving device comprising an actuator and a transmission member, the actuator being configured to drive the transmission member to rotate,
wherein the first link arm comprises an engaging portion, the transmission member being operatively coupled with the engaging portion of the first link arm to enable the actuator to drive the first link arm to rotate; and
wherein the transmission member and the engaging portion of the first link arm form a speed reduction transmission mechanism.

4. The handle device according to claim 3, wherein the transmission member comprises a transmission portion and a retaining portion adjacent to each other in a circumferential direction thereof, the transmission member being configured to drive the first link arm to rotate through cooperation between the transmission portion and the engaging portion of the first link arm, and to retain the handle in the deployed position through cooperation between the retaining portion and the engaging portion of the first link arm.

5. The handle device according to claim 4, wherein when the retaining portion of the transmission member cooperates with the engaging portion of the first link arm, the actuator is prevented from driving the first link arm to rotate via the transmission member.

6. The handle device according to claim 5, wherein the transmission portion of the transmission member comprises a cam surface, and the retaining portion of the transmission member comprises an arc surface connected to an end of the cam surface having a larger radius;
wherein the engaging portion of the first link arm comprises a rotatable wheel; and
wherein when the cam surface is in contact with the wheel, the actuator is allowed to drive the first link arm to rotate via the transmission member, and when the arc surface is in contact with the wheel, the actuator is prevented from driving the first link arm to rotate via the transmission member.

7. The handle device according to claim 6, wherein the engaging portion of the first link arm further comprises a protrusion, the wheel being rotatably disposed on the protrusion.

8. The handle device according to claim 6, wherein the radius of the arc surface is substantially the same as the maximum radius of the cam surface.

9. The handle device according to claim 5, wherein the transmission portion of the transmission member comprises a first partial gear, and the retaining portion of the transmission member comprises a locking rod connected to the first partial gear;
wherein the engaging portion of the first link arm comprises a second partial gear provided with a locking slot;
wherein when the first partial gear meshes with the second partial gear, the actuator is allowed to drive the first link arm to rotate via the transmission member, and when the first partial gear disengages from the second partial gear, a part of the locking rod enters the locking slot, preventing the actuator from driving the first link arm to rotate via the transmission member.

10. The handle device according to claim 9, wherein the locking rod comprises a locking pin provided at a distal end thereof, the locking pin being configured to move into and out of the locking slot.

11. The handle device according to claim 10, wherein the shape of the locking slot matches the movement trajectory of the locking pin during rotation, such that the movement of the locking pin in the locking slot does not cause the first link arm to rotate.

12. The handle device according to claim 11, wherein the locking slot is an arcuate slot.

13. The handle device according to claim 1, wherein the handle seat and the coupling rod are provided with limiting means connecting the coupling rod to the handle seat in a linearly movable manner.

14. The handle device according to claim 1, wherein the handle translates between the retracted position and the deployed position.

15. A vehicle, comprising a handle device of claim 1.
